(19) United States
(12) Patent Application Publication
(10) Pub. No.: US 2024/0040328 A1
(43) Pub. Date: Feb. 1, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventors: MASAYUKI YOKOYAMA, TOKYO (JP); JUNYA SUZUKI, TOKYO (JP)

(21) Appl. No.: 18/264,142

(22) PCT Filed: Jan. 6, 2022
(86) PCT No.: PCT/JP2022/000160

§ 371 Date: Aug. 3, 2023

(30) Foreign Application Priority Data
Feb. 16, 2021 (JP) 2021-022316

(51) Int. Cl. H04S 7/00

(52) U.S. Cl. CPC H04S 7/301; H04S 2420/01

(57) ABSTRACT

The present technique relates to an information processing device, an information processing method, and a program that enable spatial perception suitable for places where quietness is required.

Changes are made to a reproduced signal to be perceived by a user, based on an ultrasonic response signal returned from a space with respect to an inspection signal of an ultrasonic frequency band that is emitted into the space, according to a situation of the space.

### TECHNICAL FIELD

The present technique relates to an information processing device, an information processing method, and a program, and more particularly, to an information processing device, an information processing method, and a program that enable spatial perception suitable for places where quietness is required.

### BACKGROUND ART

PTL 1 and 2 disclose systems that allow a visually impaired person to perceive the situation around him/her by an acoustic echo to the actual emitted inspection sound or by a simulated acoustic echo generated from the position where an object is actually measured.

### CITATION LIST

### Patent Literature

[PTL 1]
JP 2018-75178A
[PTL 2]
JP 2018-78444A

### SUMMARY

### Technical Problem

The use of inspection sound of an audible frequency band to perceive the situation in the surrounding space is not suitable in a place where quietness is required.

The present technique was contrived in view of such a circumstance and enables spatial perception suitable for places where quietness is required.

### Solution to Problem

The information processing device or program of the present technique is an information processing device that includes a processing unit that makes changes to a reproduced signal to be perceived by a user, based on an ultrasonic response signal returned from a space with respect to an inspection signal of an ultrasonic frequency band that is emitted into the space, according to a situation of the space, or a program that causes a computer to function as this information processing device.

The information processing method of the present technique is an information processing method in which said processing unit of the information processing device having a processing unit makes changes to a reproduced signal to be perceived by a user, based on an ultrasonic response signal returned from a space with respect to an inspection signal in an ultrasonic frequency band emitted into the space.

In the information processing device, the information processing method, and the program of the present technique, changes are made to a reproduced signal to be perceived by a user, based on an ultrasonic response signal returned from a space with respect to an inspection signal in an ultrasonic frequency band emitted into the space.

### BRIEF DESCRIPTION OF DRAWINGS

FIG. 1 is a configuration diagram showing a configuration example of a first embodiment of an acoustic processing device to which the present technique is applied.

FIG. 2 is a diagram illustrating a frequency spectrum of a transfer function in an audible range (frequency spectrum of an audible range IR).

FIG. 3 is a diagram illustrating an example of convolution processing performed by an acoustic echo generation unit.

FIG. 4 is a flowchart illustrating a processing procedure of the acoustic processing device shown in FIG. 1.

FIG. 5 is a block diagram illustrating a configuration of a second embodiment of the acoustic processing device to which the present technique is applied.

FIG. 6 is a diagram illustrating an external configuration of an acoustic echo data collection device.

FIG. 7 is a flowchart a processing procedure of the acoustic echo data collection device.

FIG. 8 is a flowchart illustrating a processing procedure of the acoustic processing device shown in FIG. 5.

FIG. 9 is a diagram showing input/output of an inference model in an audible range IR generation unit.

FIG. 10 is a diagram showing input/output of a GAN in the audible range IR generation unit.

FIG. 11 is a block diagram showing a configuration example of hardware of a computer that executes a series of processing steps according to a program.

### DESCRIPTION OF EMBODIMENTS

Embodiments of the present technique will be described hereinafter with reference to the drawings.

### First Embodiment of Acoustic Processing Device

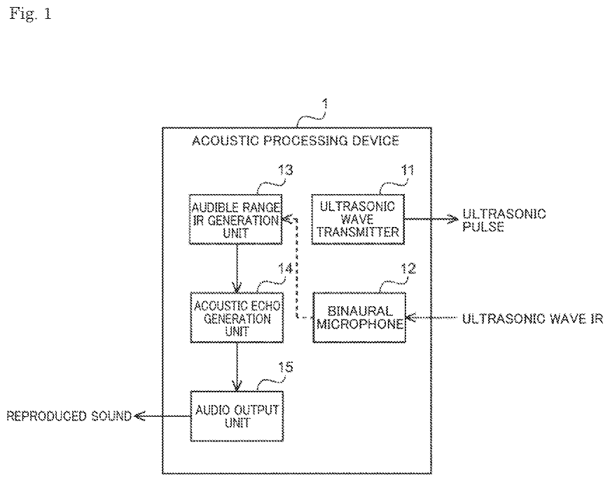

FIG. 1 is a configuration diagram showing a configuration example of a first embodiment of an acoustic processing device to which the present technique is applied.

The acoustic processing device 1 according to the present embodiment shown in FIG. 1 includes an audio output device such as earphones, headphones, and speakers that converts sound signals, which are electrical signals, into sound waves. The audio output device may be wired to or connected wirelessly to the main body of the acoustic processing device 1, or the main body of the acoustic processing device 1 may be incorporated into the audio output device. In the present embodiment, it is assumed that stereo-compatible earphones are wired to the main body of the acoustic processing device 1, and that the main body of the acoustic processing device 1 and the earphones configure the acoustic processing device 1.

The acoustic processing device 1 allows the user to perceive the situation of the space around the user by sound.

The acoustic processing device 1 has an ultrasonic wave transmitter 11, a binaural microphone 12, an audible range IR (Impulse Response) generation unit 13, an acoustic echo generation unit 14, and an audio output unit 15.

The ultrasonic wave transmitter 11 emits ultrasonic pulses (signals) as inspection waves at predetermined time intervals (predetermined cycles) in space. The ultrasonic wave transmitter 11 has, for example, a right speaker and a left speaker installed in a right earphone worn in the right ear of the user and in a left earphone worn in the left ear of the user, respectively. The right speaker emits ultrasonic pulses in a wide range of directional angles centered on the central axis facing rightward of the head of the user. From the left speaker, ultrasonic pulses are emitted over a wide range of directional angles centered on the central axis facing leftward of the head of the user. However, the speakers of the ultrasonic wave transmitter 11 may be located in areas other than the ears, and the number of speakers may be other than two.

An ultrasonic pulse emitted by the ultrasonic wave transmitter 11 consists of an ultrasonic signal in the ultrasonic frequency band of 40 kHz to 80 kHz, for example, and has a pulse width of approximately 1 ms.

The binaural microphone 12 receives, in stereo, ultrasonic impulse response signals (hereinafter referred to as ultrasonic wave IR) that are reflected (scattered) back by objects placed in space in response to ultrasonic pulses emitted into space by ultrasonic wave transmitter 11.

The binaural microphone 12 has, for example, a right microphone and a left microphone installed in the right earphone and the left earphone, respectively. The right microphone mainly receives an ultrasonic wave IR for an ultrasonic pulse emitted from the right speaker of the ultrasonic wave transmitter 1 The left microphone mainly receives an ultrasonic wave IR for an ultrasonic pulse emitted from the left speaker of the ultrasonic wave transmitter 1 However, the microphones for receiving ultrasonic waves IR may be located in areas other than the ears, and the number of microphones may be other than two.

The binaural microphone 12 may be wired or connected wirelessly to the main body of the acoustic processing device 1 as with the audio output device, or the main body of the acoustic processing device 1 may be incorporated into the binaural microphone 12.

The ultrasonic wave IR received by the binaural microphone 12 is supplied to the audible range IR generation unit 1The ultrasonic wave IR consists of two channels, the ultrasonic wave IR (R) received by the right microphone for the binaural microphone 12 and the ultrasonic wave IR (L) received by the left microphone for the binaural microphone 1Hereafter, when the ultrasonic wave IR (R) and the ultrasonic wave IR (L) are not specifically distinguished, they are simply referred to as ultrasonic wave IR.

The audible range IR generation unit 13 converts the ultrasonic wave IR from the binaural microphone 12 into an audible range IR. The audible range IR consists of two channels, an audible range IR (R) obtained from the ultrasonic wave IR (R) and an audible range IR (L) obtained from the ultrasonic wave IR (L). Hereafter, when the audible range IR (R) and the audible range IR (L) are not specifically distinguished, they are simply referred to as audible range IR.

The audible range IR generation unit 13 transforms (Fourier transformation) the ultrasonic wave IR per cycle from the binaural microphone 12, from a time domain representation to a frequency domain representation (frequency spectrum) using, for example, FFT (Fast Fourier Transform).

The audible range IR generation unit 13 shifts the frequency spectrum of the ultrasonic wave IR (ultrasonic wave IR in the frequency domain) into the audible range (audible frequency band) and adjusts the bandwidth for fitting. This generates an impulse response signal in the audible range (audible range IR) in space where the ultrasonic pulse was emitted. However, in the present embodiment, the audible range IR generated by the audible range IR generation unit 13 is the audible range IR in the frequency domain representation, and is also referred to as transfer function of the audible range, or simply transfer function.

That is, the audible range IR generation unit 13 associates the frequency of the ultrasonic band (ultrasonic frequency band) of 40 kHz to 80 kHz with the frequency of the audible range of 20 Hz to 20 kHz. Specifically, when the frequency of the ultrasonic band is x and the frequency of the audible range is y, the frequency x of the ultrasonic band and the frequency y of the audible range are linearly associated according to the relationship shown in the following Equation (1).

y={(20000−20)/(80000−40000)}·x+(2·20−20000) (1)

The audible range IR generation unit 13 sets the frequency component of the frequency x in the frequency spectrum of the ultrasonic wave IR to be the frequency component of the frequency y in the audible range, which is associated according to Equation (1). However, the association of the frequency x of the ultrasonic band with the frequency y of the audible range by Equation (1) is an example and is not limited to a linear association. The ranges of the respective frequencies that associate the frequency x in the ultrasonic band with the frequency y in the audible range is not limited to the 20 Hz to 20 kHz range in the audible range and the 40 kHz to 80 kHz range in the ultrasonic band. For example, when the frequency of the ultrasonic wave that generates the ultrasonic pulse emitted from the ultrasonic wave transmitter 11 is in a part of the frequency range from 40 kHz to 80 kHz of the ultrasonic band, this frequency range may be associated with the 20 Hz to 20 kHz range of the audible range. The audible range IR generation unit 13 applies equalization processing to the frequency components in the audible range obtained in this manner, to reflect the actual attenuation characteristics and the like according to the length of the propagation path when audible sound actually propagates through space.

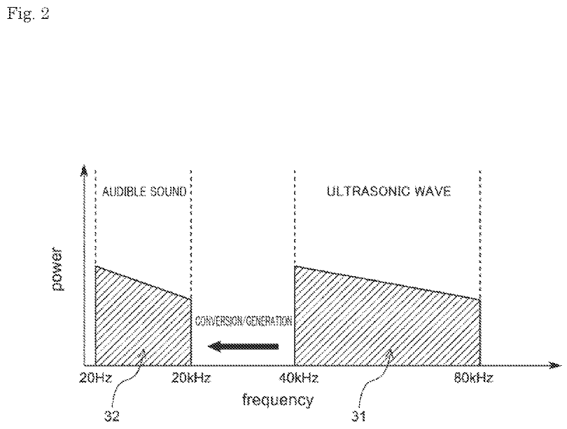

FIG. 2 is a diagram illustrating a frequency spectrum of a transfer function in an audible range that is generated from the frequency spectrum of the ultrasonic wave IR by the audible range IR generation unit 13 (frequency spectrum of the audible range IR).

In FIG. 2, a frequency spectrum 31 represents the frequency spectrum of the ultrasonic wave IR. The horizontal axis indicates frequency, and the frequency spectrum 31 has, for example, frequency components between 40 kHz and 80 kHz of the ultrasonic band. The attenuation characteristics of the frequency spectrum 31 with respect to the frequency are approximated linearly but actually vary depending on spatial situations and the like. The vertical axis is the power spectrum, and the frequency spectrum is represented by the power spectrum on the graph.

A frequency spectrum 32 represents the frequency spectrum of the transfer function in the audible range generated by the audible range IR generation unit 1The frequency spectrum 32 has, for example, frequency components between 20 Hz and 20 kHz in the audible range. The attenuation characteristics of the frequency spectrum 32 with respect to the frequency are approximated linearly as in the frequency spectrum 31, but are actually not limited thereto.

The audible range IR generation unit 13 supplies the transfer function in the audible range (audible range IR) generated from the frequency spectrum of the ultrasonic wave IR to the acoustic echo generation unit 14 shown in FIG. The transfer function in the audible range consists of two channels, a transfer function (R) generated from the ultrasonic wave IR (R) and a transfer function (L) generated from the ultrasonic wave IR (L). Hereafter, the transfer function (R) and the transfer function (L) will be referred to simply as transfer function when no particular distinction is made therebetween. When the transfer function is referred to as the audible range IR of frequency-domain representation, or simply as the audible range IR without distinguishing between time domain and frequency-domain representations, the audible range IR also consists of two channels, the audible range IR (R) generated from the ultrasonic wave IR (R) and the audible range IR (L) generated from the ultrasonic wave IR (R). When the audible range IR (R) and the audible range IR (L) will be simply referred to as audible range IR when no particular distinction is made therebetween.

The acoustic echo generation unit 14 adds an acoustic effect based on the transfer function (audible range IR) from the audible range IR generation unit 13 to the reproduced sound (signal) in the audible range heard by the user.

The reproduced sound may be, for example, a sound signal stored in advance in a memory, not shown. The reproduced sound stored in the memory may be a sound signal such as a continuous or intermittent alarm sound specialized as a notification sound to inform the user of a spatial situation, or it may be a sound signal such as music selected and listened to by the user. The reproduced sound may be a sound signal such as music supplied as streaming from an external device connected to the acoustic processing device 1 via a network such as the Internet.

The acoustic echo generation unit 14 performs convolution reverb (sampling reverb) processing to convolve the transfer function (audible range IR) from the audible range IR generation unit 13 with respect to the reproduced sound. The convolution reverb processing is also called convolution processing or convolution integration. For example, the acoustic echo generation unit 14 performs convolution processing (convolution integration) of the reproduced sound obtained by frequency conversion (FFT) of the reproduced sound to the frequency domain representation and the audible range IR. In this case, the reproduced sound in the frequency domain representation is multiplied with the transfer function. The overlap-save method and the overlap-add method is known as convolution processing methods for long reproduced sound (signal) using FFT.

The acoustic echo generation unit 14 performs inverse frequency conversion (Inverse Fast Fourier Transform, IFFT) on the reproduced sound obtained after the convolution reverb processing (convolution processing). This produces the reproduced sound of time domain representation. The acoustic echo generation unit 14 supplies the reproduced sound to the audio output unit 15.

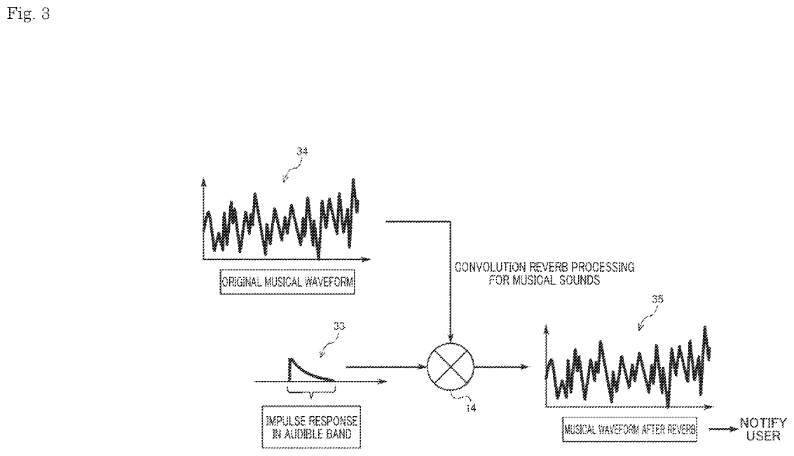

FIG. 3 is a diagram illustrating an example of the convolution processing performed by the acoustic echo generation unit 14.

In FIG. 3, an audible range IR33 represents a signal that is supplied to the acoustic echo generation unit 14 from the audible range IR generation unit 1The audible range IR33 in FIG. 3 is also the transfer function of time domain representation.

A reproduced sound 34 is a signal supplied to the acoustic echo generation unit 14 from a memory or the like, not shown. An example of the reproduced sound 34 is shown as a musical sound signal.

A reproduced sound 35 is a sound signal supplied from the acoustic echo generation unit 14 to the audio output unit 15.

Once the audible range IR33 is supplied from the audible range IR generation unit 13, the acoustic echo generation unit 14 performs convolution integration between the reproduced sound 34 and the audible range IR33 using the audible range IR33 until the next audible range IR33 is supplied. The resulting reproduced sound 35 is supplied to the audio output unit 15.

The reproduced sound consists of two channels, the right reproduced sound (R) to be heard by the right ear of the user and the left reproduced sound (L) to be heard by the left ear of the user. The acoustic echo generation unit 14 supplies the result obtained by the convolution integration between the reproduced sound (R) and the transfer function (R) (audible range IR (R)) to the audio output unit as the reproduced sound (R). The acoustic echo generation unit 14 supplies the result obtained by the convolution integration between the reproduced sound (L) and the transfer function (L) (audible range IR (L)) to the audio output unit as the reproduced sound (L). Hereafter, when no particular distinction is made between reproduced sound (R) and reproduced sound (L), they are simply referred to as reproduced sound.

The audio output unit 15 converts the reproduced sound (R) from the acoustic echo generation unit 14 into a sound wave and outputs it through the earphone (R) that the user wears in his/her right ear. The audio output unit 15 converts the reproduced sound (L) from the acoustic echo generation unit 14 into a sound wave and outputs it through the earphone (L) that the user wears in his/her left ear.

According to the acoustic processing device 1 shown in FIG. 1, the audible range IR (transfer function in the audible range), which is estimated to be obtained when an audible pulse signal is emitted in space, is generated based on the ultrasonic wave IR by the audible range IR generation unit 1Therefore, it is not necessary to emit an audible range inspection sound in the space, and the audible range IR (transfer function in the audible range) can be acquired according to the spatial situations even in places where quietness is required.

According to the acoustic processing device 1, since the audible range IR generated by the audible range IR generation unit 13 is convolved with the reproduced sound heard by the user, an acoustic effect reflecting the spatial situation (such as the arrangement of objects in the space) is added to the reproduced sound. In other words, the reproduced sound is given the acoustic effect as if it were reverberated by objects existing in the space. Therefore, the user can perceive that some object is approaching in the surroundings, by the acoustic effect of the reproduced sound. Since music and other content can be used as reproduced sound as in a normal music player, the user does not suffer from listening to the sound for a long time. Even if the user is immersed in music or other content, such as when the user moves while listening to the content as reproduced sound, the user can perceive the spatial situation from the changes in the acoustic effect of the reproduced sound, thus preventing unforeseen situations such as collisions or falls.

It is also possible to modulate (downsampling, stretching, etc.) the reflected sound of the inspection sound in the ultrasonic frequency band to the audible range and present it to the user. However, in such a case, it becomes difficult to intuitively perceive the spatial situation because the reflected sound characteristics are different from those of the audible sound. It is not suitable for the user to use the music player on a daily basis for a long period of time because the user would have to listen to monotonous inspection sounds for a long time.

<Processing Procedure of Acoustic Processing Device 1>

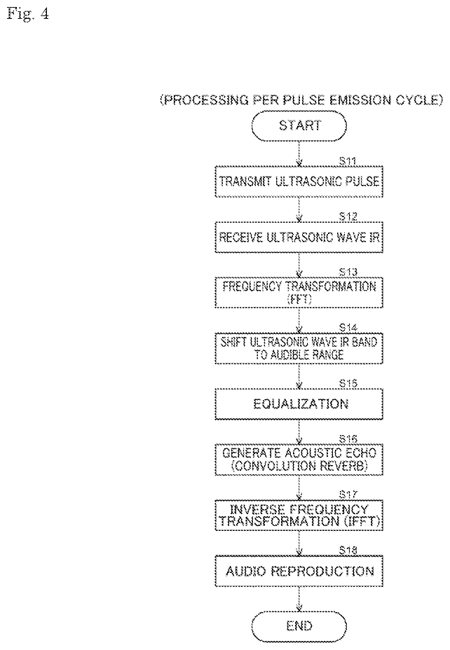

FIG. 4 is a flowchart illustrating a processing procedure of the acoustic processing device 1 shown in FIG. Note that this flowchart shows processing performed during one cycle of ultrasonic pulses emitted periodically into space.

In step S11, the ultrasonic wave transmitter 11 emits (transmits) ultrasonic pulses into space. The processing proceeds from step S11 to step S12.

In step S12, the binaural microphone 12 receives the ultrasonic wave IR returning from the space. The processing proceeds from step S12 to step S13.

In step S13, the audible range IR generation unit 13 performs frequency conversion by FFT on the ultrasonic wave IR received in step S12, to obtain the ultrasonic wave IR of frequency domain representation (frequency spectrum of the ultrasonic wave IR), that is, the transfer function of the audible range. The processing proceeds from step S13 to step S14.

In step S14, the audible range IR generation unit 13 shifts the bandwidth of the frequency spectrum of the ultrasonic wave IR obtained in step S13 to the audible range. The processing proceeds from step S14 to step S15.

In step S15, the audible range IR generation unit 13 applies equalization processing on the frequency components (frequency spectrum) in the audible range shifted in step S14 to reflect the actual attenuation characteristics according to the length of the propagation path when the audible sound actually propagates through the space. As a result, the frequency spectrum of the audible range IR range (transfer function of the audible range) is obtained. The processing proceeds from step S15 to step S16.

In step S16, the acoustic echo generation unit 17 performs frequency conversion on the reproduced sound (signal) and performs convolution processing (convolution reverb processing) between the reproduced sound and the audible range IR obtained in step S1This gives an acoustic effect to the reproduced sound according to the spatial situation. The processing proceeds from step S16 to step S17.

In step S17, the acoustic echo generation unit 17 performs inverse frequency conversion from the frequency domain representation to the time domain representation of the reproduced sound to which the acoustic effect is applied in step S1The processing proceeds from step S17 to step S18.

In step S18, the audio output unit 15 outputs the reproduced sound converted to a time domain representation in step S17 through the earphones or the like.

The acoustic processing device 1 repeats the processing from step S11 to step S18 each time the ultrasonic wave transmitter 11 outputs an ultrasonic pulse (one pulse) in space.

### Second Embodiment of Acoustic Processing Device

A second embodiment of the acoustic processing device to which the present technique is applied will be described next.

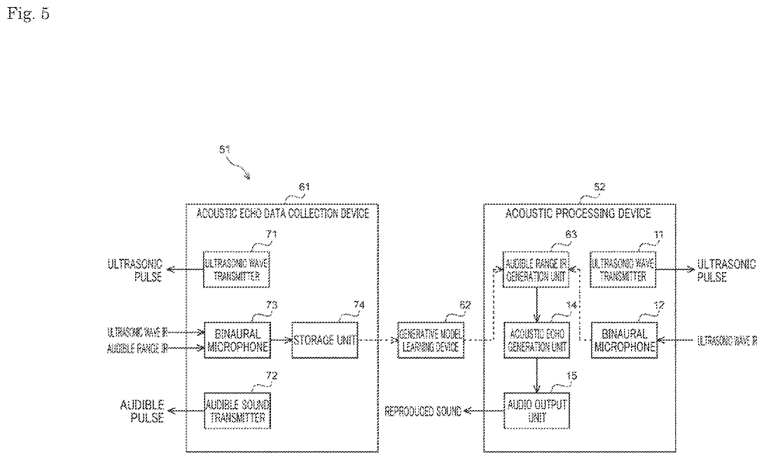

FIG. 5 is a block diagram illustrating a configuration of the second embodiment of the acoustic processing device to which the present technique is applied. Parts in common with the acoustic processing device 1 shown in FIG. 1 are marked with the same symbols, and detailed explanations are omitted as appropriate.

A processing system 51 in FIG. 5 also includes a device used to construct an acoustic processing device 52 which is the second embodiment of the acoustic processing device to which the present technique is applied.

The processing system 51 includes the acoustic processing device 52, an acoustic echo data collection device 61, and a generative model learning device 62.

The acoustic processing device 52 includes the ultrasonic wave transmitter 11, the binaural microphone 12, the acoustic echo generation unit 14, the audio output unit 15, and an audible range IR generation unit 6Therefore, the acoustic processing device 52 shares the same features as the acoustic processing device 1 of FIG. 1 in that it has the ultrasonic wave transmitter 11, the binaural microphone 12, the acoustic echo generation unit 14, and the audio output unit 15.

However, the acoustic processing device 52 differs from the acoustic processing device 1 of FIG. 1 in that it is provided with the audible range IR generation unit 63 in place of the audible range IR generation unit 13 shown in FIG. 1.

The audible range IR generation unit 63 infers the audible range IR for the ultrasonic wave IR from the binaural microphone 12 by means of an inference model having the structure of a neural network. The inference model is generated by supervised learning using a machine learning technique in the generative model learning device 6The inference model generated by the generative model learning device 62 is implemented in the audible range IR generation unit 63.

The acoustic echo data collection device 61 collects a data set used for learning the inference model.

The acoustic echo data collection device 61 includes an ultrasonic wave transmitter 71, an audible sound transmitter 72, a binaural microphone 73, and a storage unit 74.

The ultrasonic wave transmitter 71 emits ultrasonic pulses (signals) with a pulse width of approximately 1 ms, consisting of ultrasonic signals in an ultrasonic frequency band of 40 kHz to 80 kHz, similar to the ultrasonic wave transmitter 11 of the acoustic processing device The period of the ultrasonic pulse does not have to match that of the ultrasonic pulse of the ultrasonic wave transmitter 11 of the acoustic processing device 1, and can be set to any desired period.

The audible sound transmitter 72 emits an audible pulse (signal) with a pulse width of approximately 1 ms, consisting of an audible sound signal in an audible range of 20 Hz to 20 kHz. The pulse width of the audible pulse is the same as that of the ultrasonic pulse emitted from the ultrasonic wave transmitter 71, but may be different. The period of the audible pulse is the same as that of the ultrasonic pulse emitted from the ultrasonic wave transmitter 71, but the timing of the emission of the ultrasonic pulse and the timing of the emission of the audible pulse are staggered so that the time when the audible pulse is on does not overlap with the time when the ultrasonic pulse is on.

The binaural microphone 73 receives an ultrasonic wave IR and an audible range IR.

The storage unit 74 stores the ultrasonic wave IR and the audible range IR received by the binaural microphone 73.

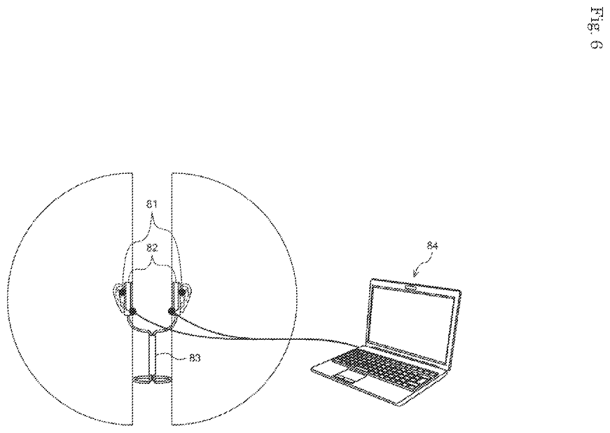

FIG. 6 is a diagram illustrating an external configuration of the acoustic echo data collection device 61.

In FIG. 6, a dummy head 82, which imitates the periphery of the left and right human ears, is supported on a stand 8At positions 81, 81 near the outer right and left ears of the dummy head 82, left and right ultrasonic speakers of the ultrasonic wave transmitter 71, which emit ultrasonic pulses, and left and right audible range speakers of the audible sound transmitter 72, which emit audible pulses, are installed. The left and right microphones of the binaural microphone 73 are incorporated in the left and right portions of the dummy head 8The left and right microphones of the binaural microphone 73 receive both ultrasonic and audible pulses, respectively.

The speakers and the microphones arranged on the dummy head 82 are each connected to a personal computer 84.

The personal computer 84 is connected to the speakers and the microphones of the dummy head 82 and executes a predetermined program, thereby constituting the acoustic echo data collection device 6The personal computer 84 may also include the generative model learning device 62.

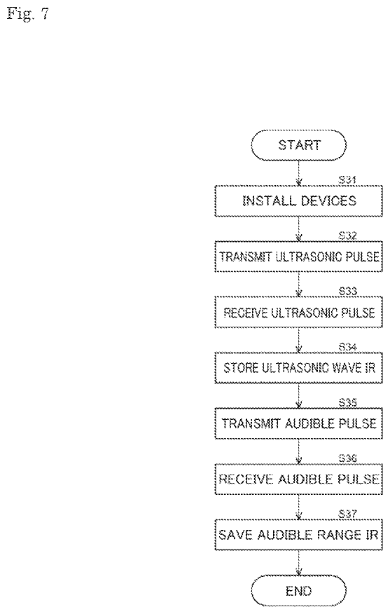

FIG. 7 is a flowchart a processing procedure of the acoustic echo data collection device 61.

In step S31, the location where learning data for the inference model is to be collected is determined and the acoustic echo data collection device 61 is installed at this location. For example, the acoustic echo data collection device is installed in a space that can accommodate the use of the acoustic processing device 52 in various locations as much as possible, such as outdoors, in a hallway, in a room, in a room with furniture, or the like. The processing proceeds from step S31 to step S32.

In step S32, the ultrasonic wave transmitter 71 transmits (emits) ultrasonic pulses (single pulses) from the left and right ultrasonic speakers of the dummy head 82 to a surrounding area. The processing proceeds from step S32 to step S33.

In step S33, the ultrasonic pulses (ultrasonic wave IR) emitted in step S32 and returning from space are received by the left and right microphones of the binaural microphone 7The processing proceeds from step S33 to step S34.

In step S34, the storage unit 74 stores the right ear-side ultrasonic wave IR (R) and the left ear-side ultrasonic wave IR (L) received by the binaural microphone 73 in step S3The processing proceeds from step S34 to step S35.

In step S35, the audible sound transmitter 72 transmits (emits) audible pulses (single pulses) from the left and right audible range speakers of the dummy head 82 to a surrounding area. The processing proceeds from step S35 to step S36.

In step S36, the audible pulses (audible range IR) emitted in step S35 and returning from the space are received by the left and right microphones of the binaural microphone 7The processing proceeds from step S36 to step S37.

In step S37, the storage unit 74 stores the right ear-side audible range IR (R) and the left ear-side audible range IR (L) received by the binaural microphone 73 in step S36.

In step S34, the data of the ultrasonic waves IR for the two channels, the ultrasonic wave IR (R) and the ultrasonic wave IR (L), are saved. In step S37, the data of the audible range IR for the two channels, the audible range IR (R) and the audible range IR (L), are stored. The data of the ultrasonic waves IR for these two channels and the data of the audible ranges IR for the two channels are tied together to become a pair of data, with the ultrasonic waves IR as input data and the audible ranges IR as teacher data (correct data). By repeating the processing from step S32 to step S37, the amount of pair data increases, and the data set, which is a collection of the pair data, is stored in the storage unit 74.

Either the ultrasonic waves IR and the acquisition/storage (steps S32 to S34) and the acquisition/storage of the audible ranges IR (steps S35 to S37) may be performed first.

The learning data (data set) described above may be generated by a simulator that can reproduce spatial objects and their stereophonic sound on a virtual space of CG (Computer Graphics) by a game engine such as Unity or Unreal Engine.

The generative model learning device 62 in FIG. 5 learns an inference model in machine learning by using the data set stored in the storage unit 7For the inference model, the input data is taken as the ultrasonic waves IR and the output data is taken as the audible ranges IR inferred from the input data. If the number of samples per cycle of ultrasonic pulses and audible pulses is n, the input and output of the inference model are 2n-dimensional for the two channels respectively.

The generative model learning device 62 learns the inference model using the data of the ultrasonic waves IR as the input data and the data of the audible ranges IR as the teacher data from each pair data in the data set stored in the storage unit 7When the learning is completed, the learned inference model is implemented in the audible range IR generation unit 63 of the acoustic processing device 52.

For example, U-Net, Fully Convolutional Network and the like are known as networks capable of outputting different data of the same dimension as the input.

<Processing Procedure of Acoustic Processing Device>

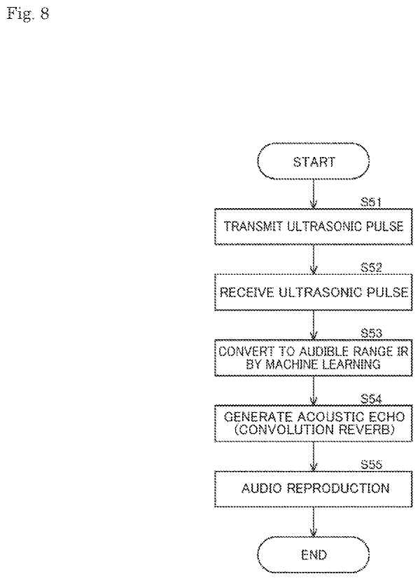

FIG. 8 is a flowchart illustrating a processing procedure of the acoustic processing device 52 shown in FIG. This flowchart shows the processing performed during one cycle of ultrasonic pulses periodically emitted in space.

In step S51, the ultrasonic wave transmitter 11 emits (transmits) ultrasonic pulses into space. The processing proceeds from step S51 to step S52.

In step S52, the binaural microphone 12 receives the ultrasonic wave IR returning from the space. The processing proceeds from step S52 to step S53.

In step S53, the audible range IR generation unit 63 inputs the ultrasonic wave IR received in step S52 into the inference model and calculates the audible range IR by the inference model. The processing proceeds from step S53 to step S54.

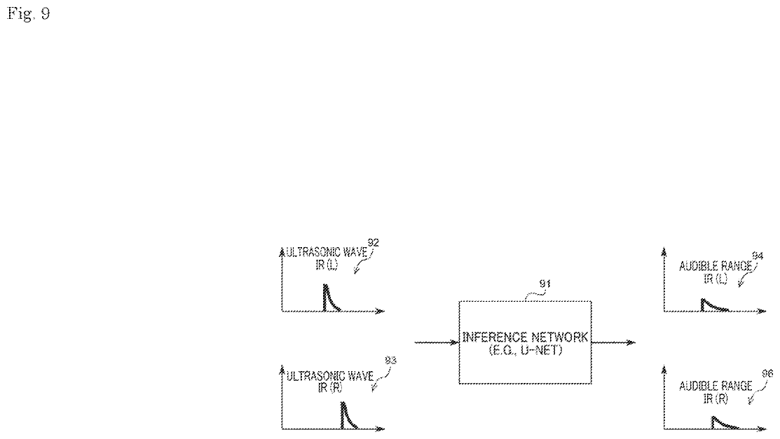

FIG. 9 is a diagram showing input/output of the inference model in the audible range IR generation unit 63.

In FIG. 9, an inference network 91, which is the inference model, receives, as the input data, data of n number of samples of an ultrasonic wave IR (R) 93 from the binaural microphone 12 and data of n number of samples of an ultrasonic wave IR (L) 9The inference network 91 outputs data of n samples of an audible range IR (R) 96 and data of n samples of an audible range IR (L) 94 with respect to the input data.

In FIG. 8, in step S54, the acoustic echo generation unit 17 performs frequency conversion on the reproduced sound (signal) and performs convolution processing (convolution reverb processing) with the audible range IR obtained in step S5This gives an acoustic effect to the reproduced sound according to the spatial situation. The processing proceeds from step S54 to step S55.

In step S55, the audio output unit 15 outputs the reproduced sound obtained in step S54 from the earphones or the like.

The acoustic processing device 52 repeats the processing from step S51 to step S55 each time the ultrasonic wave transmitter 11 outputs an ultrasonic pulse (one pulse) in space.

The inference model of the audible range IR generation unit 63 generates the ultrasonic wave IR in time domain representation as the input data and the audible range IR in time domain representation as the output data, but the inference model may generate more. The inference model may also generate the ultrasonic wave IR in frequency domain representation (frequency spectrum of the ultrasonic wave IR) as the input data and the audible range IR in frequency domain representation (frequency spectrum of the audible range IR) as the output data, that is, the transfer function in the audible range.

According to the acoustic processing device 52 of the second embodiment described above, the audible range IR (transfer function of the audible range) that is estimated to be obtained when an audible pulse signal is emitted in space is generated based on the ultrasonic wave IR by the audible range IR generation unit 1Therefore, it is not necessary to emit an audible range inspection sound in the space, and the audible range IR (transfer function of the audible range) can be obtained according to the spatial situations even in places where quietness is required.

According to the acoustic processing device 52, since the audible range IR generated by the audible range IR generation unit 13 is convolved with the reproduced sound heard by the user, an acoustic effect reflecting the spatial situation (such as the arrangement of objects in the space) is added to the reproduced sound. In other words, the reproduced sound is given the acoustic effect as if it were reverberated by objects existing in the space. Therefore, the user can perceive that some object is approaching in the surroundings by the acoustic effect of the reproduced sound. Since music and other content can be used as the reproduced sound as in a normal music player, the user does not suffer from listening to the sound for a long time. Even if the user is immersed in music or other content, such as when the user moves while listening to the content as reproduced sound, the user can perceive the spatial situation from the changes in the acoustic effect of the reproduced sound, thus preventing unforeseen situations such as collisions or falls.

<Modification of Acoustic Processing Device>

In the acoustic processing device 52 shown in FIG. 5, the frequency bandwidth of the ultrasonic pulse emitted from the ultrasonic wave transmitter 11 may be narrow. For example, there are cases where the ultrasonic speaker can only emit 40 kHz sine waves. In such a case, the inference model of the audible range IR generation unit 63 does not provide sufficient information to infer the audible range IR. In such cases, the inference model represented by a GAN (Generative Adversarial Network), which generates a reasonable audible range IR, may be used to generate an audible range IR from the ultrasonic wave IR.

When the GAN is used as the inference model, the acoustic echo data collection device 61 in FIG. 5 collects pair data of the ultrasonic wave IR and the audible range IR using the procedure shown in FIG. 8, to construct a data set. Using the ultrasonic wave IR of each pair data as the input data and the audible range IR as the teacher data (correct data), the generative model learning device 62 trains the GAN. Digital sample data of the audible range IR is generated from digital sample data of the ultrasonic wave IR by using the GAN algorithm that generates images from images or sound from sound. For this generation, a pix2pix technique is used, for example.

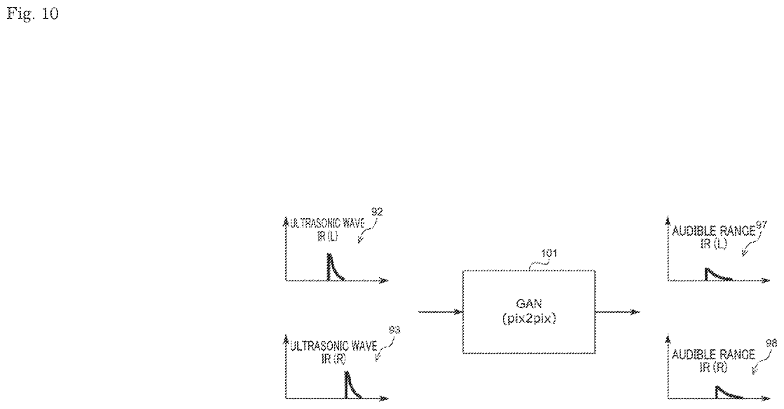

FIG. 10 is a diagram showing input/output of the GAN in the audible range IR generation unit 63.

In FIG. 10, a GAN 101, which is the inference model, receives, as the input data, data of n samples of the ultrasonic wave IR (L) 92 from the binaural microphone 12 and data of n samples of the ultrasonic wave IR (R) 9The GAN 101 generates the data of n samples of the audible range IR (R) and the data of n samples of the audible range IR (L) as the input data.

According to this, even if the audible range IR generated by the inference model does not accurately reproduce the detailed reverberation characteristics of real space (e.g., materials, etc.), reverberation effects such as delay of early reflection, changes in sound pressure, the length of reverberation, and changes in frequency characteristics, are added to the reproduced sound. Therefore, the user can perceive the location of space and obstacles by the acoustic effect of the reproduced sound.

The acoustic echo data collection device 61 shown in FIG. 5 can be installed in various spaces to acquire and store the ultrasonic waves IR and the audible ranges IR, thereby constructing a data set. In order to construct a large data set, it is necessary to visit many spaces to install the microphones, speakers, and the like of the acoustic echo data collection device 61 and repeat the process of acquiring and storing the ultrasonic waves IR and the audible ranges IR. This requires time and travel costs.

On the other hand, simulators that freely arrange objects in virtual space and reproduce physical simulations in the virtual space are being developed, especially for game engines such as Unity and Unreal Engine. Such simulators allow audio sources and microphones to be freely arranged in the virtual space, and some even support high-resolution audio formats (e.g., 192 kHz sampling frequency). For ultrasonic waves of 40 kHz to 80 kHz, it is possible to collect data of both ultrasonic waves IR and audible ranges IR on the simulators. Since no travel time is required and parallel processing can speed up the process, large data sets can be constructed at relatively high speed.

When the data are collected on a simulator, the reverberation characteristics on the simulator may not always match those of the real world. In such a case, a data set is constructed on the simulator and then converted to a data set closer to the real-world reverberation characteristics by domain conversion. CycleGAN, for example, is known as a domain conversion method. CycleGAN is a type of GAN that, unlike pix2pix, does not require pair data and can collect data from both domains (in this case, reverberations on the simulator and reverberations in the real world) independently. For the purpose of approximating real-world echo characteristics, if the reverberation characteristics on the simulator are close to the real-world reverberation characteristics to some extent, domain conversion can be performed with relatively small data collection compared to data collection for machine learning inference models.

As described above, the present technique can be applied to the case where the reproduced sound (signal) is read as a reproduced signal and vibrations corresponding to the reproduced signal are presented to the user in the foregoing embodiment. In other words, the present technique can also be applied to the case where changes are made to the vibration signal (reproduced signal), which allows the user to perceive the vibrations, instead of the reproduced sound (signal), based on the ultrasonic wave IR, in accordance with the spatial situation.

The present technique is effective in various fields due to its ability to make the user perceive the spatial situation, especially the approach of an object, etc., by sound and vibrations. For example, as obstacle sensors, a speaker and a microphone are installed on the exterior of a vehicle such as an automobile, to emit ultrasonic pulses around the vehicle, and ultrasonic waves IR are received by the microphone. The reproduced sound (reproduced signal), which is modified based on the ultrasonic waves IR received by the microphone, may be output from the speaker or other device in the vehicle, or may be presented to the user as seat vibration or the like.

<Program>

The series of processing steps performed in the acoustic processing device 1, the acoustic processing device 52, the acoustic echo data collection device 61, or the generative model learning device 62 described above can also be executed by hardware or software. In a case where the series of processing steps is executed by software, a program that constitutes the software is installed on a computer. Here, examples of the computer include a computer embedded in dedicated hardware or a general-purpose personal computer capable of executing various functions by installing various programs.

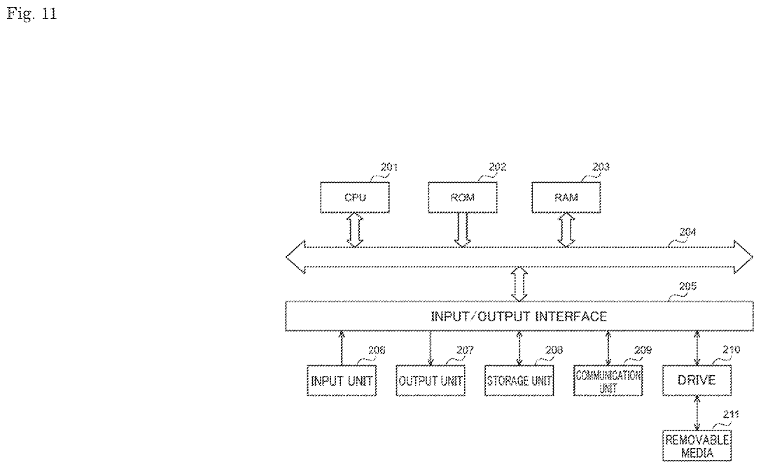

FIG. 11 is a block diagram illustrating a configuration example of hardware of a computer that executes, by means of a program, respective processing steps executed by the acoustic processing device 1, the acoustic processing device 52, the acoustic echo data collection device 61, or the generative model learning device 62.

In the computer, a CPU (Central Processing Unit) 201, a ROM (Read Only Memory) 202, and a RAM (Random Access Memory) 203 are connected to each other by a bus 204.

An input/output interface 205 is further connected to the bus 20An input unit 206, an output unit 207, a storage unit 208, a communication unit 209, and a drive 210 are connected to the input/output interface 205.

The input unit 206 is constituted of a keyboard, a mouse, a microphone, or the like. The output unit 207 is constituted of a display, a speaker, or the like. The storage unit 208 is a hard disk, non-volatile memory, or the like. The communication unit 209 is a network interface or the like. The drive 210 drives a removable medium 211 such as a magnetic disk, an optical disc, a magneto-optical disk, or a semiconductor memory.

In the computer configured as described above, for example, the CPU 201 loads a program stored in the storage unit 208 into the RAM 203 via the input/output interface 205 and the bus 204 and executes the program, to perform the series of processing steps described above.

The program executed by the computer (the CPU 201) can be recorded on, for example, the removable medium 211 serving as a package medium, and provided. The program can be supplied via a wired or wireless transmission medium such as a local area network, the Internet, or digital satellite broadcasting.

In the computer, by mounting the removable medium 211 on the drive 210, it is possible to install the program in the storage unit 208 via the input/output interface 20The program can be received by the communication unit 209 via a wired or wireless transfer medium and can be installed in the storage unit 20In addition, the program can be installed in advance in the ROM 202 or the storage unit 208.

Note that the program executed by the computer may be a program that performs processing chronologically in the order described in the present specification or may be a program that performs processing in parallel or at the necessary timing, such as when a call is made.

The present technique can be also configured as follows:

(1)

An information processing device, comprising a processing unit that makes changes to a reproduced signal to be perceived by a user, based on an ultrasonic response signal returned from a space with respect to an inspection signal of an ultrasonic frequency band that is emitted into the space, according to a situation of the space.

(2)

The information processing device according to (1), wherein the inspection signal is a pulse signal emitted at a predetermined cycle.

(3)

The information processing device according to (1) or (2), wherein the situation of the space is a situation of arrangement of objects in the space.

(4)

The information processing device according to (1) or (3), wherein the reproduced signal is a sound signal in an audible frequency band.

(5)

The information processing device according to (4), wherein the processing unit applies an acoustic effect based on the ultrasonic response signal in accordance with a situation of the space.

(6)

The information processing device according to (3), wherein the processing unit generates a transfer function for a sound signal of an audible frequency band in the space based on the ultrasonic response signal, and applies the acoustic effect based on the transfer function to the reproduced signal.

(7)

The information processing device according to (6), wherein the processing unit multiplies the reproduced signal of a frequency domain obtained by Fourier transformation of the reproduced signal by the transfer function, thereby applying the acoustic effect to the reproduced signal.

(8)

The information processing device according to (6) or (7), wherein the processing unit generates the transfer function based on a frequency component of the ultrasonic response signal.

(9)

The information processing device according to (8), wherein the processing unit includes, as processing for generating the transfer function, processing for associating a frequency of the ultrasonic frequency band with a frequency of the audible frequency band, and setting a frequency component corresponding to each frequency of the ultrasonic response signal in the ultrasonic frequency band as a frequency component of the transfer function for each frequency in the audible frequency band associated with each frequency of the ultrasonic response signal.

(10)

The information processing device according to (8), wherein the processing unit estimates a frequency component of the transfer function with respect to the frequency component of the ultrasonic response signal by using an inference model generated by machine learning.

(11)

The information processing device according to (5), wherein the processing unit generates an impulse response signal of the audible frequency band in the space based on the ultrasonic response signal, and applies the acoustic effect based on the impulse response signal to the reproduced signal.

(12)

The information processing device according to (11), wherein the processing unit applies the acoustic effect to the reproduced signal by performing convolution integration of the reproduced signal and the impulse response signal.

(13)

The information processing device according to (11) or (12), wherein the processing unit generates the impulse response signal from the ultrasonic response signal using an inference model in machine learning.

(14)

The information processing device according to any one of (5) to (13), wherein the ultrasonic response signal is composed of a right ear ultrasonic response signal detected for a right ear and a left ear ultrasonic response signal detected for a left ear, and

the processing unit makes the changes to the reproduced signal for the right ear to be perceived by the right ear of the user based on the right ear ultrasonic response signal, and makes the changes to the reproduced signal for the left ear to be perceived by the left ear of the user based on the left ear ultrasonic response signal.

(15)

The information processing device according to (14), wherein the ultrasonic response signal is acquired by a right microphone for acquiring the right ear ultrasonic response signal placed in the right ear of the user, and a left microphone for acquiring the left ear ultrasonic response signal placed in the left ear of the user.

(16)

The information processing device according to (1) or (2), wherein the reproduced signal is a vibration signal that causes the user to perceive vibration.

(17)

An information processing method, in which

a processing unit of an information processing device having the processing unit makes changes to a reproduced signal to be perceived by a user, based on an ultrasonic response signal returned from a space with respect to an inspection signal of an ultrasonic frequency band that is emitted into the space, according to a situation of the space.

(18)

A program causing a computer to function as:

a processing unit that makes changes to a reproduced signal to be perceived by a user, based on an ultrasonic response signal returned from a space with respect to an inspection signal of an ultrasonic frequency band that is emitted into the space, according to a situation of the space.

### REFERENCE SIGNS LIST

1, 52 Acoustic processing device
11 Ultrasonic wave transmitter
12 Binaural microphone
13 Audible range IR generation unit
14 Acoustic echo generation unit
15 Audio output unit
61 Acoustic echo data collection device
62 Generative model learning device

1. An information processing device, comprising a processing unit that makes changes to a reproduced signal to be perceived by a user, based on an ultrasonic response signal returned from a space with respect to an inspection signal of an ultrasonic frequency band that is emitted into the space, according to a situation of the space.

2. The information processing device according to claim 1, wherein the inspection signal is a pulse signal emitted at a predetermined cycle.

3. The information processing device according to claim 1, wherein the situation of the space is a situation of arrangement of objects in the space.

4. The information processing device according to claim 1, wherein the reproduced signal is a sound signal in an audible frequency band.

5. The information processing device according to claim 4, wherein the processing unit applies an acoustic effect based on the ultrasonic response signal in accordance with a situation of the space.

6. The information processing device according to claim 5, wherein the processing unit generates a transfer function for a sound signal of an audible frequency band in the space based on the ultrasonic response signal, and applies the acoustic effect based on the transfer function to the reproduced signal.

7. The information processing device according to claim 6, wherein the processing unit multiplies the reproduced signal of a frequency domain obtained by Fourier transformation of the reproduced signal by the transfer function, thereby applying the acoustic effect to the reproduced signal.

8. The information processing device according to claim 6, wherein the processing unit generates the transfer function based on a frequency component of the ultrasonic response signal.

9. The information processing device according to claim 8, wherein the processing unit includes, as processing for generating the transfer function, processing for associating a frequency of the ultrasonic frequency band with a frequency of the audible frequency band, and setting a frequency component corresponding to each frequency of the ultrasonic response signal in the ultrasonic frequency band as a frequency component of the transfer function for each frequency in the audible frequency band associated with each frequency of the ultrasonic response signal.

10. The information processing device according to claim 8, wherein the processing unit estimates a frequency component of the transfer function with respect to the frequency component of the ultrasonic response signal by using an inference model generated by machine learning.

11. The information processing device according to claim 5, wherein the processing unit generates an impulse response signal of the audible frequency band in the space based on the ultrasonic response signal, and applies the acoustic effect based on the impulse response signal to the reproduced signal.

12. The information processing device according to claim 11, wherein the processing unit applies the acoustic effect to the reproduced signal by performing convolution integration of the reproduced signal and the impulse response signal.

13. The information processing device according to claim 11, wherein the processing unit generates the impulse response signal from the ultrasonic response signal using an inference model in machine learning.

14. The information processing device according to claim 5, wherein
the ultrasonic response signal is composed of a right ear ultrasonic response signal detected for a right ear and a left ear ultrasonic response signal detected for a left ear, and
the processing unit makes the changes to the reproduced signal for the right ear to be perceived by the right ear of the user based on the right ear ultrasonic response signal, and makes the changes to the reproduced signal for the left ear to be perceived by the left ear of the user based on the left ear ultrasonic response signal.

15. The information processing device according to claim 14, wherein the ultrasonic response signal is acquired by a right microphone for acquiring the right ear ultrasonic response signal placed in the right ear of the user, and a left microphone for acquiring the left ear ultrasonic response signal placed in the left ear of the user.

16. The information processing device according to claim 1, wherein the reproduced signal is a vibration signal that causes the user to perceive vibration.

17. An information processing method, in which a processing unit of an information processing device having the processing unit makes changes to a reproduced signal to be perceived by a user, based on an ultrasonic response signal returned from a space with respect to an inspection signal of an ultrasonic frequency band that is emitted into the space, according to a situation of the space.

18. A program causing a computer to function as:
a processing unit that makes changes to a reproduced signal to be perceived by a user, based on an ultrasonic response signal returned from a space with respect to an inspection signal of an ultrasonic frequency band that is emitted into the space, according to a situation of the space.
